(19) United States
(12) Patent Application Publication
(10) Pub. No.: US 2005/0071503 A1
(43) Pub. Date: Mar. 31, 2005

(54) Hierarchical scheduling

(75) Inventors: Lyle E. Grosbach, Rochester, MN (US); Glen H. Handlogten, Rochester, MN (US); James F. Mikos, Rochester, MN (US); David A. Norgaard, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/675,677

(22) Filed: Sep. 30, 2003

(51) Int. Cl. G06F 15/173

(52) U.S. Cl. 709/239

(57) ABSTRACT

In a first aspect of the invention, a first method is provided for hierarchical scheduling. The first method includes the steps of (1) selecting a first winning entry from one of a plurality of main calendars during a time unit, the first winning entry indicating a first pipe to be serviced during the time unit (2) determining that no pipe flow corresponding to the winning first pipe currently needs to be serviced during the time unit (3) selecting a second winning entry from the plurality of main calendars during the time unit, the second winning entry indicating a second pipe or an autonomous flow to be serviced during the time unit; and (4) servicing the autonomous flow or a pipe flow corresponding to the second winning entry during the time unit. Numerous other aspects are provided.

### CROSS REFERENCE TO RELATED APPLICATION

The present application is related to U.S. patent application Ser. No. ______, filed ______ and titled “HIERARCHICAL SCHEDULING” (Attorney Docket No. ROC920030061), which is hereby incorporated by reference herein in its entirety.

### FIELD OF THE INVENTION

The present invention relates generally to network processors, and more particularly to methods and apparatus for hierarchical scheduling.

### BACKGROUND

A network processor may be coupled to one or more network devices, such as a computer, through the network processor's input ports. Each output port of the network processor is connected to a network of limited system bandwidth. Only a certain amount of data may be transmitted by that network at one time.

To ensure access to the network, consumers are willing to purchase access to a portion of the system bandwidth from the owner thereof. Therefore, the owner of the system bandwidth may divide the system bandwidth into portions and sell the portions to one or more consumers. Typically, a purchaser of a portion of the system bandwidth does not use all of their purchased portion of the system bandwidth all of the time. Consequently, in order to increase revenues, the owner of the system bandwidth will typically sell more system bandwidth than may be available at any one time (i.e., will oversubscribe). If a consumer wants to use more than his purchased portion of system bandwidth, he may temporarily use additional bandwidth (e.g., bandwidth that has been purchased by another consumer but is not in use at that moment). However, when many consumers are attempting to use all or a large portion of their purchased bandwidth at the same time, the availability of bandwidth is unpredictable. Some consumers may be allowed to use more than their purchased portion of system bandwidth, while other consumers may only be allowed to use a portion of their purchased bandwidth.

Therefore, an improved system of efficiently providing access to a limited system bandwidth is needed.

FIG. 1 is an exemplary schematic diagram of a conventional network processor system 100. The network processor system 100 may include a network processor 102. The network processor 102 may receive data from autonomous flows 104-118 or pipes 120, 122, 124. Autonomous flows and pipes are peers (e.g., compete equally for system bandwidth). Each autonomous flow 104, 106, 108, 110, 112, 114, 116, 118 represents an individual connection from the network processor 102 to a network device (not shown). Each pipe 120, 122, 124 may include one or more pipe flows 130. A pipe flow 130 represents an individual connection from the network processor 102 to a network device (not shown) that is grouped together with other individual connections to network devices to form a pipe 120, 122, 124 (e.g., an Internet Service Provider may purchase a group of pipe flows from the owner of the system bandwidth, and sell the pipe flows to consumers).

In the conventional network processor system 100 shown in FIG. 1, the network processor 102 receives data from a plurality of autonomous flows 104-118 and from a plurality of pipes 120, 122, 124, which each include a plurality of pipe flows (e.g., 130). The received data is to be transmitted from the same output port 132. Each output port 132 (only one output port 132 shown) of the network processor 102 is connected to a network connection of limited system bandwidth. Therefore, data from all autonomous flows and pipes may not be serviced at the same time (i.e., data from each autonomous flow or pipe may not be transmitted at the same time). In the conventional network processor 102 shown in FIG. 1, every autonomous flow 104-118 or pipe 120-124 may be assigned a priority, for example, high, medium, or low priority, and a bandwidth. The priority assigned to an autonomous flow or pipe determines how frequently the autonomous flow or pipe will be serviced. The bandwidth assigned to the autonomous flow or pipe determines the portion of the system bandwidth that is made available to the autonomous flow or pipe when it is serviced.

The conventional network processor system 100 shown in FIG. 1 may use a separate calendar for each priority type to schedule autonomous flows and/or pipes to be serviced (e.g., a high priority calendar, a medium priority calendar and a low priority calendar). Each such calendar includes a group of memory addresses that will be checked repeatedly for entries identifying autonomous flows or pipes that need to be serviced. Alternatively, a single calendar may include entries identifying autonomous flows and/or pipes of one or more priority types. A different group or area of memory addresses of the calendar may be used to store entries identifying autonomous flows and/or pipes of each priority type. Each of these groups will be checked repeatedly to identify entries that need servicing.

When a group of memory addresses is checked repeatedly, a pointer, which points to a first memory address in the group during a first time unit, may be advanced during each successive time unit to point to a next memory address in the group. If the last address of the calendar is checked during the time unit, during the next time unit, the first address of the calendar may be checked. Accordingly, for convenience the calendars herein are shown schematically as a single box and referred to in the singular, although it will be understood that a calendar may comprise either a single calendar containing a plurality of priorities, or a set of calendars, preferably each containing only a single priority.

The greater the distance between the memory address of a scheduled entry in a calendar and the memory address currently being checked in the calendar, the longer the autonomous flow or pipe identified by that scheduled calendar entry must wait to be serviced. The data received by the network processor 102 may be used to identify an autonomous flow or pipe that corresponds to the data. Based upon previously-assigned priorities and bandwidths, the network processor 102 may determine an appropriate memory address in the calendar for the autonomous flow or pipe.

When a network processor system 100 includes a plurality of calendars, each of which is of a different priority type, an entry from the low priority calendar that identifies an autonomous flow or pipe that needs to be serviced during a time unit (e.g., during a scheduling opportunity) will not be selected as a winner and serviced until entries in the high and/or medium priority calendars that identify an autonomous flow or pipe that needs to be serviced during that time unit have been serviced. Likewise, an entry in the medium priority calendar that identifies an autonomous flow or pipe that needs to be serviced during a time unit will not be selected as a winner and serviced until an entry in the high priority calendar that identifies an autonomous flow or pipe that needs to be serviced during that time unit has been serviced.

In the conventional network processor system of FIG. 1, if an autonomous flow has been identified to be serviced, the data received from the autonomous flow is transmitted from the output port 132. In contrast, because a pipe includes one or more pipe flows, an additional lookup must be performed when a calendar identifies a pipe that needs to be serviced. The network processor must maintain a list for each pipe that includes every pipe flow included in the pipe. Each list indicates the last pipe flow that was serviced from the list. When the calendar identifies the pipe that needs to be serviced, a lookup in the list corresponding to the identified pipe is performed and the next pipe flow in the list will be serviced.

FIG. 2 is a block diagram of a scheduler logic 200 included in the conventional network processor system 100 of FIG. 1. The scheduler logic 200 may be used by the conventional network processor system 100 to schedule autonomous flows or pipes to be serviced. The scheduler logic 200 may include a main calendar 202 (which may include one or more calendars of various priorities). The main calendar 202 may be coupled to a memory 204 (e.g., via enqueue and new attach logic 208 and an arbitration unit 210) and to a list 206 of pipe flows for each pipe (e.g., via dequeue and reattach logic 212). The arbitration unit 210 arbitrates reads from and writes to the memory 204. For example, the enqueue and new attach logic 208 may receive data that identifies a pipe. The enqueue and new attach logic 208 may access the memory 204 (e.g., via the arbitration unit 210) and determine the pipe identified by the received data is of a low priority and is assigned a certain bandwidth. Based upon this information, the enqueue and new attach logic 208 will determine an appropriate address of the main calendar 202 in which to write an entry identifying the pipe corresponding to the received data and will write the identified entry therein (i.e., will schedule the pipe to be serviced).

When an entry is written into the main calendar 202, it may be written into a location of the main calendar 202 as a single entry. The entry written into the calendar may be a pointer to a control structure (described in detail below) that corresponds to an autonomous flow or pipe (a pipe in this example). However, for convenience, the entry in the calendar will be referred to as the autonomous flow or pipe itself, rather than as a pointer to a control structure.

The main calendar 202 will check its memory addresses for entries identifying a pipe or autonomous flow that needs to be serviced, as described above when discussing the operation of calendars. When the main calendar 202 reaches the entry identifying the pipe corresponding to the data received during a time unit, the main calendar 202 will select that pipe entry to be serviced (i.e., will select that pipe as a winner), assuming no higher-priority entries from the calendar need to be serviced during that time unit.

As mentioned above, because a pipe includes one or more pipe flows, an additional lookup must be performed when the main calendar 202 identifies a pipe that needs to be serviced during the time unit. Therefore, when the main calendar 202 identifies a low priority pipe that needs to be serviced (i.e., selects a winner) assuming no higher priority pipes need to be serviced during the same time unit, the scheduler logic 200 (e.g., via dequeue and reattach logic 212) performs a lookup in a table 206 which lists pipe flows for each pipe. The scheduler logic 200 thus looks up a list of pipe flows that corresponds to the identified pipe. The list indicates the next pipe flow to be serviced. That pipe flow will be serviced (i.e., data from that pipe flow will be transmitted from the output port 132 of the network processor system 100).

The conventional network processor system 100 does not provide a means to distinguish between the pipe flows included in a pipe. Each pipe flow is serviced one time before any pipe flow is serviced a second time. Consequently, the conventional network processor system 100 provides uniformly slow transmissions for both high and low priority flows. However, because pipe flows may include data of varying size and importance, a network administrator may desire to service a first pipe flow multiple times before a second pipe flow is serviced once. The network administrator may also desire to use a large bandwidth when servicing the first pipe flow and a small bandwidth when servicing the second pipe flow.

### SUMMARY OF THE INVENTION

In a first aspect of the invention, a first method is provided for hierarchical scheduling. The first method includes the steps of (1) selecting a first winning entry from one of a plurality of main calendars during a time unit, the first winning entry indicating a first pipe to be serviced during the time unit (2) determining that no pipe flow corresponding to the winning first pipe currently needs to be serviced during the time unit (3) selecting a second winning entry from the plurality of main calendars during the time unit, the second winning entry indicating a second pipe or an autonomous flow to be serviced during the time unit; and (4) servicing the autonomous flow or a pipe flow corresponding to the second winning entry during the time unit.

In a second aspect of the invention, a first apparatus is provided that includes at least one memory and scheduler logic coupled to the at least one memory. The at least one memory is adapted to store one or more quality of service priority parameters corresponding to one or more pipes and pipe flows, and the scheduler logic is adapted to (1) select a first winning entry from one of a plurality of main calendars during a time unit, the first winning entry indicating a first pipe to be serviced during the time unit (2) determine that no pipe flow corresponding to the winning first pipe currently needs to be serviced during the time unit (3) select a second winning entry from the plurality of main calendars during the time unit, the second winning entry indicating a second pipe or autonomous flow to be serviced during the time unit; and (4) service the autonomous flow or pipe flow corresponding to the second winning entry during the time unit. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE DRAWINGS

FIG. 1 is an exemplary schematic diagram of a conventional network processor system.

FIG. 2 is a block diagram of a scheduler logic included in the conventional network processor system of FIG. 1.

FIG. 3 is a block diagram of exemplary scheduler logic in which the present invention for selecting multiple entries to be serviced during a time unit in a network processor with hierarchical scheduling may be implemented.

FIG. 4 illustrates an exemplary method for hierarchical scheduling of data received from a flow.

FIG. 5 illustrates a process according to the methods and apparatus of copending application Ser. No. ______ (Attorney Docket No. ROC920030061) of selecting from a main calendar a winning pipe that is empty.

FIG. 6 is a block diagram of a plurality of memory addresses in a high priority calendar, a medium priority calendar and a low priority calendar.

FIG. 7 illustrates a method for selecting multiple entries to be serviced during a time unit in accordance with an embodiment of the present invention.

FIG. 8 illustrates a block diagram of a plurality of memory addresses in a high priority calendar, a medium priority calendar, and a low priority calendar in which the inventive method is performed.

FIG. 9 illustrates a block diagram of a plurality of memory addresses in a high, medium, and low priority calendar in which the inventive method is performed.

### DETAILED DESCRIPTION

One method for distinguishing between the pipe flows included in a pipe and therefore, providing hierarchical scheduling of data (i.e., distinguishing between pipe flows included in a pipe, in addition to distinguishing between pipes and/or autonomous flows in a network processing system) has been addressed in commonly-assigned copending application serial No. ______ filed on even date herewith (Attorney Docket No. ROC920030061). According to the methods and apparatus of copending application Ser. No. ______ (Attorney Docket No. ROC920030061), a main or primary calendar is used to schedule autonomous flows and/or pipes to be serviced and a secondary calendar is used to schedule pipe flows to be serviced. Each autonomous flow, pipe, and/or pipe flow from which the network processor system 100 may receive data may be assigned a priority and a bandwidth. The priority and bandwidth corresponding to the autonomous flow, pipe, and/or pipe flow determine the location in a calendar in which an entry for that autonomous flow, pipe and/or pipe flow is inserted and therefore, determine when the autonomous flow, pipe, and/or pipe flow is scheduled to be serviced.

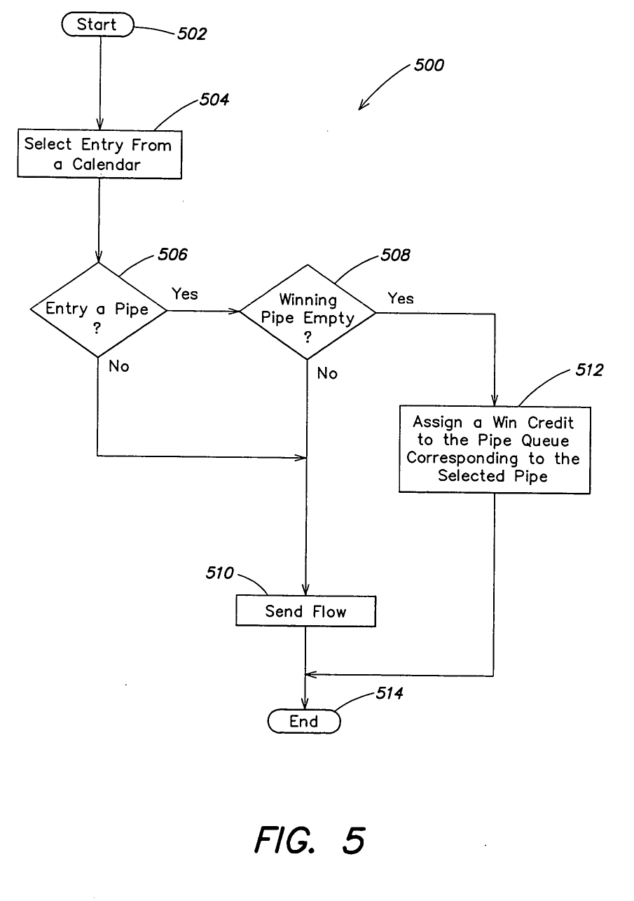

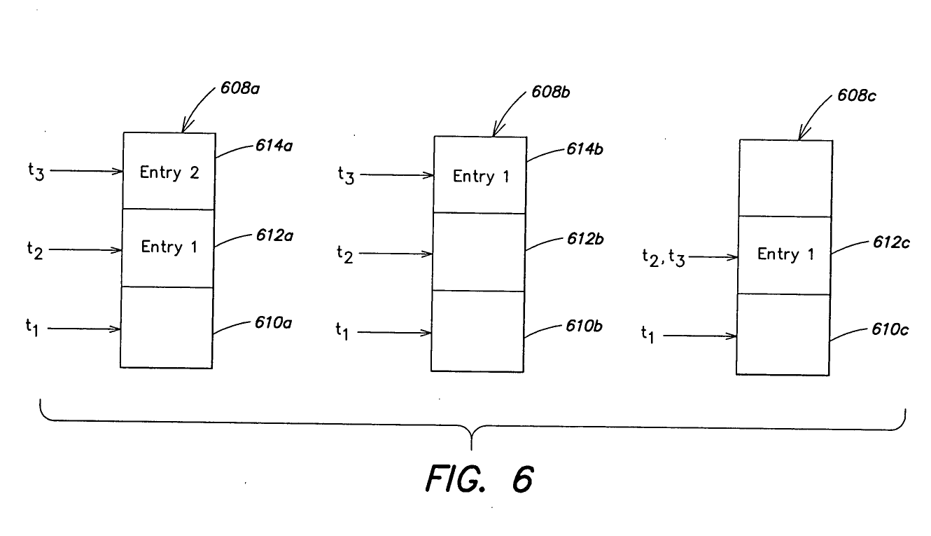

According to the methods and apparatus of copending application Ser. No. ______ (Attorney Docket No. ROC920030061), a pipe is selected to be serviced during a given time unit, and if no pipe flow included in that selected pipe needs to be serviced during that time unit, no pipe flow will be serviced during that time unit as shown in FIGS. 5-6 of the present invention. Consequently no data will be transmitted during that time unit.

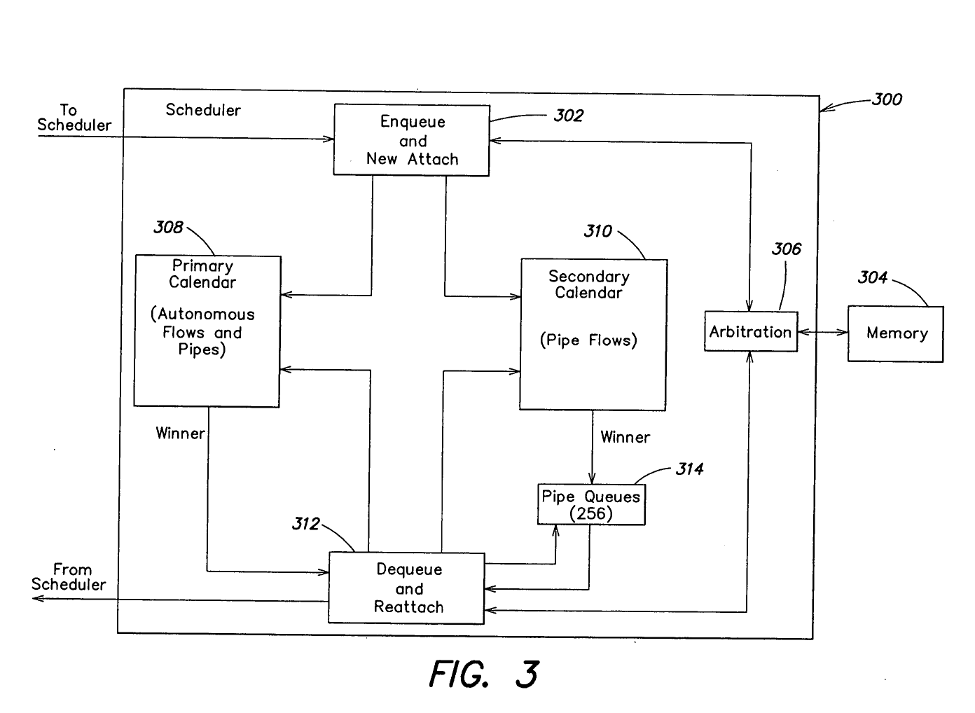

The present invention introduces methods and apparatus for selecting multiple entries to be serviced during a time unit from chained or unchained entries in a network processor with hierarchical scheduling and will be described with reference to FIGS. 3-4, and 7-9. Specifically, if a first entry selected to be serviced during a time unit is empty, a second entry may be selected to be serviced, and serviced during the time unit.

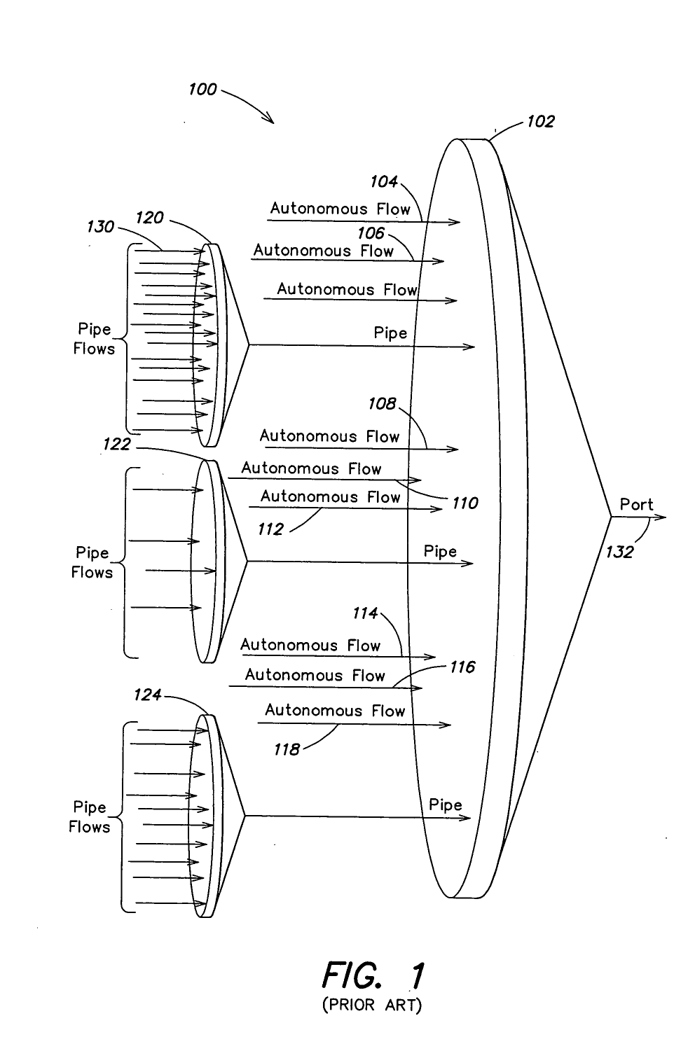

FIG. 3 is a block diagram of exemplary scheduler logic 300 in which the present inventive methods and apparatus for selecting multiple entries to be serviced during a time unit in a network processor with hierarchical scheduling may be implemented. The exemplary scheduler logic 300 may be included in a network processor system (e.g., a network processor system similar to the conventional network processor system shown in FIG. 1). As in the conventional network processor system 100, the network processor system (not shown) that includes the inventive scheduler logic 300 may receive data from autonomous flows and/or pipes. The autonomous flows and pipes are peers. Each pipe may include one or more pipe flows. In contrast to the conventional network processor system 100, the scheduler logic 300 includes a secondary calendar 310 which is used to schedule pipe flows and a pipe queue table 314 which may include one or more (e.g., 256) pipe flows corresponding to a given pipe. The secondary calendar 310 and the pipe queue table 314 will be described in detail below.

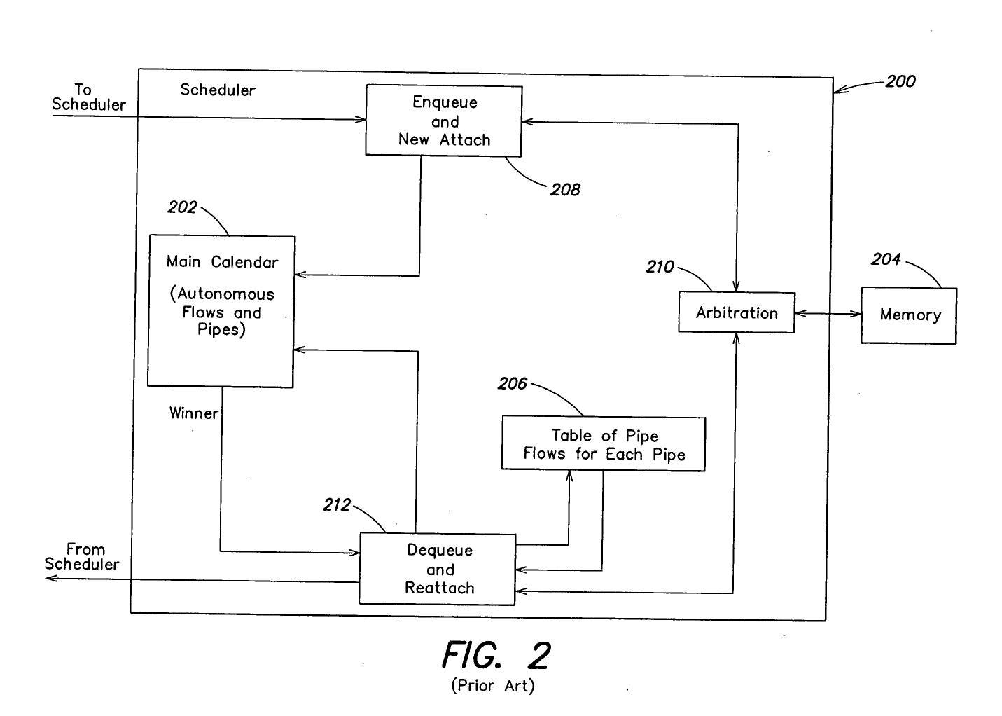

The scheduler logic 300 includes enqueue and new attach logic 302, which is coupled to a memory 304 (e.g., via an arbitration unit 306). As in the conventional scheduler logic 200, the arbitration unit 306 arbitrates writes to and reads from the memory 304. The enqueue and new attach logic 302 may receive data which identifies a flow (e.g., an autonomous flow or a pipe flow). As in the memory 204 of the conventional scheduler logic 200 shown in FIG. 2, the memory 304 of the scheduler logic 300 may be configured to store a priority and bandwidth for each autonomous flow or pipe. In addition, the memory 304 may store a priority and bandwidth for each pipe flow that may be included in each pipe.

The memory 304 may also be used to store information describing the structure of a queue (e.g., information describing the structure of a queue of data frames or cells received from a flow). The priority and bandwidth information corresponding to an autonomous flow, pipe, and/or pipe flow stored in the memory 304 may be provided by a user, such as a network administrator, during system initialization, for example.

Based on the flow (i.e., autonomous flow or pipe flow) identified by the data, the enqueue and new attach logic 302 retrieves priority and bandwidth information corresponding to the identified flow and processes the data differently depending on whether it is an autonomous flow or a pipe flow as is described under the subheadings below.

### The Flow Identified by the Data Corresponds to an Autonomous Flow

If the received data identifies an autonomous flow, priority and bandwidth information corresponding to that autonomous flow is retrieved from the memory 304. The enqueue and new attach logic 302 determines whether an entry exists in the primary (or main) calendar 308 for the autonomous flow identified by the data. As previously noted, although only a single primary calendar 308 is shown in the scheduler logic 300 of FIG. 3, additional calendars that correspond to different priority types may exist. If an entry exists in the primary calendar 308 for the identified autonomous flow, the enqueue and new attach logic 302 will not write an entry in the primary calendar 308. If an entry does not exist in the primary calendar 308 for the autonomous flow, data regarding the autonomous flow is written into the primary calendar 308. Similar to the main calendar 202 of the conventional scheduler logic 200, the primary calendar 308 includes groups of memory addresses (e.g., in one or more calendars) that will be checked repeatedly for entries identifying autonomous flows or pipes that need to be serviced.

The scheduler logic 300 handles the scheduling of autonomous flows in a manner similar to that used by the conventional scheduler logic 200. The enqueue and new attach logic 302 determines an appropriate memory address in the calendar for the autonomous flow. For example, if the autonomous flow is of a low priority, it will be placed in a low priority portion of the primary calendar 308. Further, if the autonomous flow is a new entry to the low-priority portion of the primary calendar, it will be placed near the memory address currently being checked in that low-priority portion of the primary calendar. The greater the distance between the memory address of a scheduled entry and the memory address of the calendar currently being checked, the longer the autonomous flow or pipe identified by that scheduled calendar entry must wait to be serviced.

In contrast to the main calendar 202 of the conventional logic circuit 200, an entry stored in the primary calendar 308 may be chained. A chained entry represents a plurality of pipes and/or autonomous flows that are scheduled to be serviced during the same time unit or scheduling opportunity. More specifically, an autonomous flow or pipe entry in the primary calendar 308 that is chained may point to a control structure (e.g., control block) corresponding to the autonomous flow or pipe. A portion of that control structure (a next chain entry pointer) will point to a control structure that corresponds to the next autonomous flow or pipe of the chained entry. However, for convenience, a chained entry in the primary calendar will be referred to as pointing to the next autonomous flow or pipe entry in the chain.

Therefore, an entry may be considered to exist in the primary calendar 308 if it is a single entry in the primary calendar or is included in a chained entry of the primary calendar 308. When a new entry is written into the primary calendar 308, it may be written into a location of the primary calendar 308 as a single entry. Alternatively, the entry may be written in a location of the primary calendar 308 that already includes an entry for an autonomous flow or pipe. In that case, the new entry will replace the previously-existing entry in that location and the new entry will point to the previously-existing entry.

In operation, the primary calendar may identify an entry that needs servicing from each priority group during a time unit. Thereafter, from the identified entries the primary calendar selects a winner to be serviced during the time unit.

As mentioned above, entries in the primary calendar may be chained. If the winner selected from the identified entries is a chained entry, after the data from the winner is transmitted the winner will be replaced in the calendar by the next autonomous flow or pipe entry in the chain. If the entry replacing the winner is the last entry of the chain, it is treated as an unchained entry.

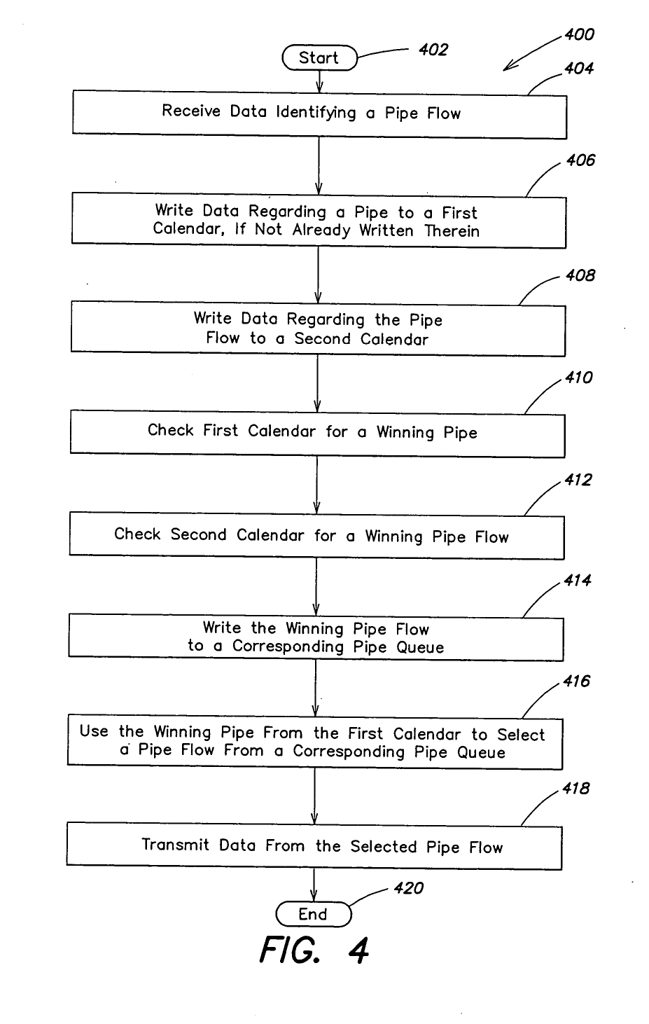

Although unchained and/or chained entries may be written to and selected from the primary calendar during a time unit, while describing the general operation of the inventive scheduler logic 300 with reference to FIGS. 3 and 4, for simplicity it is assumed that only enqueue and new attach unchained entries are written to and selected from the primary calendar 308.

The primary calendar 308 may be coupled to dequeue and reattach logic 312. The primary calendar 308 notifies the dequeue and reattach logic 312 regarding the selected winner. If the winner is an autonomous flow, the data received from the autonomous flow will be transmitted from the output port 132 using the bandwidth assigned to that autonomous flow.

Like the enqueue and new attach logic 302, the dequeue and reattach logic 312 may be coupled to the memory 304 (e.g., via the arbitration unit 306). The dequeue and reattach logic 312 may retrieve priority and bandwidth information corresponding to the autonomous flow selected as the winner from the memory 304. The dequeue and reattach logic 312 will reattach (e.g., rewrite) the autonomous flow entry in an appropriate memory address of the primary calendar 308 based upon the retrieved information.

Similar to the writing of a new entry for an autonomous flow or pipe in a location of the primary calendar that already includes an entry for an autonomous flow or pipe, the dequeue and reattach logic 312 may reattach an autonomous flow or pipe that was just serviced in a memory address of the primary calendar that is already occupied to form a chained entry.

### The Flow Identified by the Data Corresponds to a Pipe Flow

As mentioned above, the scheduler logic 300 includes enqueue and new attach logic 302, which is coupled to a memory 304. The enqueue and new attach logic 302 may receive data which identifies a flow (e.g., an autonomous flow or pipe flow). If the data received by the enqueue and new attach logic 302 identifies a pipe flow, priority and bandwidth information corresponding to that pipe flow may be retrieved from the memory 304. The enqueue and new attach logic 302 may also retrieve from the memory 304 priority and bandwidth information corresponding to a pipe that includes the pipe flow.

As mentioned above, the enqueue and new attach logic 302 may be coupled to the primary calendar 308. The enqueue and new attach logic 302 determines whether an entry exists in the primary calendar 308 for the pipe corresponding to the pipe flow identified by the received data. If such an entry does not exist in the primary calendar 308, data regarding the pipe is written into the primary calendar 308 in a manner similar to that of the autonomous flow. The primary calendar functions as described above to select a winner from the identified entries to be serviced. The primary calendar 308 then notifies the dequeue and reattach logic 312 regarding the selected winner.

The enqueue and new attach logic 302 may be coupled to a secondary calendar 310, and may determine whether an entry exists in the secondary calendar 310 for the pipe flow identified by the received data. If such an entry does not exist in the secondary calendar, data regarding the pipe flow is written into the secondary calendar 310. Like the primary calendar, the secondary calendar 310 may include priority groups of memory addresses (e.g., in one or more calendars) that will be checked repeatedly for entries identifying pipe flows that need to be serviced. The secondary calendar may identify an entry that needs servicing from each priority group during a time unit. Thereafter, from the identified entries the secondary calendar selects a winner to be serviced during the time unit.

The secondary calendar 310 may be coupled to a pipe queue table 314 (e.g., a memory) that stores pipe queues. Each pipe queue includes one or more entries of pipe flows. The secondary calendar 310 notifies the pipe queue table 314 of the winner selected from the secondary calendar 310. The pipe queue table 314 places the selected winner (a pipe flow) on a queue for the pipe that includes the winning pipe flow.

The pipe queue table 314 is coupled to the dequeue and reattach the logic 312. When the primary calendar notifies the dequeue and reattach logic 312 of the winner from the primary calendar (which is assumed to be a pipe in this example) the dequeue and reattach logic 312 selects a pipe flow from a queue in the pipe queue table 314 that corresponds to the winning pipe from the primary calendar 308. The dequeue and reattach logic 312 will transmit data received from that pipe flow through the output port 132 of the network processor system (not shown) using the bandwidth assigned to that pipe flow.

The dequeue and reattach logic 312 may be coupled to the memory 304 (e.g., via the arbitration unit 306). The dequeue and reattach logic 312 may retrieve priority and bandwidth information corresponding to the pipe flow that was selected as a winner from the secondary calendar 310. The dequeue and reattach logic 312 will reattach the pipe flow entry in an appropriate memory address of the secondary calendar 310 based upon the retrieved information. Similarly, the dequeue and reattach logic 312 may retrieve priority and bandwidth information corresponding to the pipe that was selected as a winner from the primary calendar 308, and may reattach the pipe entry in an appropriate memory address of the primary calendar 308 based upon the retrieved information.

Similar to the writing of a new entry for an autonomous flow or pipe in a location of the primary calendar that already includes an entry for an autonomous flow or pipe, the dequeue and reattach logic 312 may reattach an autonomous flow or pipe that was just serviced in a memory address of the primary calendar that is already occupied and may thus form a chained entry.

It should be noted that the enqueue and new attach logic 302 and the dequeue and reattach logic 312 may include logic devices, such as an application specific integrated circuit, a programmable logic circuit, or similar standard logic. The primary calendar 308, secondary calendar 310, and the pipe queue table 314 may include an on-chip memory, such as an SRAM or the like. Other memory such as an off-chip memory may be used. The memory 304 may be external memory, such as a DRAM of the like, for example.

The operation of the scheduler logic 300 is now described with reference to FIGS. 3 and 4, which illustrate an exemplary method for hierarchical scheduling of data received from a flow. For convenience, it is assumed that all data is received from pipe flows. However, it should be noted that the method of hierarchical scheduling may be used on a network processor system that receives data from pipe flows and/or autonomous flows. It is also assumed that all entries in the primary calendar are unchained. However, it should be noted that the primary calendar of the present apparatus may include unchained and/or chained entries. The method for scheduling of autonomous flows was discussed above and may be performed according to conventional methods and therefore will not be repeated.

With reference to FIGS. 3 and 4, in step 402 the method of hierarchical scheduling of data received from a flow begins. In step 404, data identifying a pipe flow is received. For example, the enqueue and new attach logic 302 of the scheduler logic 300 may receive data identifying a flow. The data may include a size of a frame or cell received in a flow, and a pointer to the frame or cell received in a flow.

The enqueue and new attach logic 302 will retrieve information stored as Quality of Service (QoS) parameters from the memory 304, such as priority and bandwidth information, which corresponds to the flow identified by the received data. As mentioned above, in this example it is assumed the received data identifies a pipe flow. The memory 304 may include a control structure (e.g., a control block) for each flow (e.g., autonomous flow and/or pipe flow) that may be received by the network processor system (not shown). The control block for each autonomous flow and/or pipe flow may include values for one or more priority parameters and one or more bandwidth parameters. The priority parameters define how frequently a pipe flow will be serviced. The bandwidth parameters define the portion of the system bandwidth that will be made available to the pipe flow when the pipe flow is chosen to be serviced.

The enqueue and new attach logic 302 will retrieve from the memory 304 information stored as Quality of Service (QoS) parameters, such as, priority and bandwidth information, which corresponds to the pipe that includes the pipe flow identified by the received data. In addition to including control structures (e.g., control blocks) that include pipe bandwidth and priority parameters, the memory 304 may include one or more control structures that include values for Quality of Service (QoS) parameters, such as priority and bandwidth parameters, for each pipe.

The enqueue and new attach logic 302 determines whether an entry exists in the primary (first) calendar 308 for the pipe corresponding to the pipe flow identified by the received data. If an entry for the pipe exists in the first calendar 308, the pipe has already been scheduled to be serviced and the enqueue and new attach logic 302 does not need to write data regarding the pipe in the first calendar 308. However, if an entry for the pipe does not exist in step 406, the enqueue and new attach logic 302 will write data regarding the pipe to the first calendar 308.

The enqueue and new attach logic 302 determines whether an entry exists in the secondary (second) calendar 310 for the pipe flow identified by the received data. If an entry for the pipe flow exists, the pipe flow has already been scheduled to be serviced and the enqueue and new attach logic 302 does not need to write data regarding the pipe flow in the second calendar 310. However, if an entry for the pipe flow does not exist, in step 408, the enqueue and new attach logic 302 will write data regarding the pipe flow in an appropriate address of the second calendar 310. This data may include information about the pipe that includes the pipe flow. For example, if the pipe flow is of a high priority, it will be placed in a high priority portion of the secondary calendar 310. Further, if the pipe flow is a new entry to the high priority portion of the secondary calendar 310, it will be placed near the memory address currently being checked in that high priority portion of the secondary calendar 310, so that the pipe flow will be serviced more quickly.

In step 410, the first calendar 308 is checked for a winning pipe. The primary calendar may identify an entry from each priority portion of the primary calendar to be serviced during a time unit (e.g., one or more clock cycles). The primary calendar selects a winner (e.g., an entry to be serviced) from the entries identified to be serviced during the time unit. In this example, the winning entry is assumed to correspond to a pipe. The primary calendar 308 notifies the dequeue and reattach logic 312 of the winning pipe, for example, via a bus.

In step 412, the second calendar 310 is checked for a winning pipe flow. More specifically, the secondary calendar may identify an entry that needs servicing from each priority group during the time unit. The secondary calendar selects a winner from the identified entries to be serviced during the time unit. In one embodiment, four priority types may be used to schedule the pipes and flows received by the network processing system, therefore, the secondary calendar 310 may be divided into four groups. Each of these groups or areas will be checked repeatedly. Other numbers of priority types may be used. The secondary calendar 310 may identify an entry from each of these groups or areas (e.g., identify a high priority pipe flow, a medium priority pipe flow and a low priority pipe flow to be serviced). During each clock cycle of the network processor (not shown) that includes the scheduler logic 300, one of the entries identified by the secondary calendar will be selected as a winning entry (e.g., as an entry to be serviced). The winning entry corresponds to a pipe flow. The secondary calendar 310 notifies the pipe queue table 314 of the winning pipe flow via a bus, for example.

In step 414, the winning pipe flow is written into a corresponding pipe queue. More specifically, the pipe queue table 314 may receive information about the winning pipe flow and the pipe that includes the winning pipe flow. The pipe queue table 314 may retrieve priority and bandwidth information corresponding to that pipe flow from the memory 304. Entries in each queue may be arranged in priority order. If two or more entries have the same priority, those entries may be arranged by the length of time each entry has been stored in the queue. Based upon the information received from the secondary calendar 310 and the information retrieved from the memory 304, the winning pipe flow from the secondary calendar 310 will be placed in one of the queues stored in the pipe queue table 314. More specifically, the winning pipe flow entry will be placed in a queue for the pipe that includes the winning pipe flow.

The placement of the winning pipe flow entry in the pipe queue may be determined by the information retrieved from the memory 304. For example, if the pipe queue previously contained an entry for a high priority pipe flow, followed by an entry for a medium priority pipe flow, followed by an entry for a low priority pipe flow, and the winning pipe flow is of a high priority, the entry for the winning pipe would be inserted in the pipe queue before the medium priority pipe flow entry and after previously existing high priority pipe flow entry.

In step 416, the winning pipe from the first calendar 308 is used to select a pipe flow from a corresponding pipe queue. As mentioned above, the primary calendar 308 notifies the dequeue and reattach logic 312 of the winning pipe. The dequeue and reattach logic 312 may determine whether the pipe queue (stored in the pipe queue table 314) that corresponds to the winning pipe is empty (i.e., the pipe queue does not include any pipe flows that need to be serviced during the time unit). The steps performed when the pipe queue that corresponds to the winning pipe is empty include novel aspects of the present invention and will be described later.

In this example, it is assumed that the pipe queue that corresponds to the winning pipe is not empty. The dequeue and reattach logic 312 will select a pipe flow entry from the pipe queue (stored in the pipe queue table 314) that corresponds to the winning pipe. More specifically, the dequeue and reattach logic 312 will select from the pipe queue, the highest priority pipe flow entry that has been in the queue for the longest time, as the pipe flow entry to be serviced.

In step 418, data from the selected pipe flow is transmitted. One or more frames or cells received by the network processor system (not shown) from the selected pipe flow will be transmitted through the output port of the network processor system. In step 420, assuming there is no additional data for the winning pipe flow, the method of FIG. 4 ends. Otherwise the process proceeds as described below.

If there is additional data for the winning pipe flow the dequeue and reattach logic 312 determines additional data (e.g., frames or cells) identifying the selected pipe flow needs to be serviced. To make this determination the dequeue and reattach logic 312 will access the information stored in memory describing the structure of a queue. If additional data identifying the selected flow needs to be serviced, the dequeue and reattach logic 312 will retrieve priority and bandwidth information corresponding to that pipe flow from the memory 304. Based upon that information, the dequeue and reattach logic 312 may determine an appropriate memory address in the secondary calendar 310 in which to reattach (i.e., rewrite) the selected pipe flow entry so that the selected pipe flow may be scheduled to be serviced again.

For example, assuming the selected pipe flow is of a high priority, the pipe flow is written into the high priority portion of the secondary calendar 310. Because the pipe flow was just serviced, the memory address selected in the high priority portion of the secondary calendar may be a greater distance from the memory address currently being checked in the high priority group than when the pipe flow was initially attached (e.g., written) to the secondary calendar 310. Therefore, the pipe flow may have to wait a longer time to be serviced after it is reattached to the secondary calendar 310 than when it is initially attached to the secondary calendar 310.

Alternatively, if the dequeue and reattach logic 312 determines additional data identifying the selected pipe flow does not need to be serviced, the selected pipe flow will not be reattached to the second calendar 310.

The dequeue and reattach logic 312 may determine whether the selected pipe is empty (i.e., no received data that needs to be serviced during this time unit identifies a pipe flow included in the selected pipe) by accessing information describing the structure of a queue for each pipe flow included in the selected pipe that is stored in the memory 304. If additional data identifying a flow, that is included in the selected pipe, needs to be serviced, the dequeue and reattach logic 312 will retrieve priority and bandwidth information corresponding to the selected pipe from the memory 304. Based on that information, the dequeue and reattach logic 312 may determine an appropriate memory address in the primary calendar 308 in which to reattach (i.e., rewrite) the selected pipe entry.

For example, similar to the reattaching of a pipe flow entry to the secondary calendar 310, if the selected pipe is of a high priority, the pipe is written into a memory address of the high priority portion of the primary calendar 308. Because the pipe was just serviced, the memory address selected in the high priority portion of the primary calendar 308 may be a greater distance from the memory address currently being checked in that portion of the calendar than when the pipe was initially attached (e.g., written to the primary calendar 308). Therefore, the pipe may have to wait a longer time to be serviced after it is reattached to the primary calendar 308 than when it is initially attached to the primary calendar 308.

Alternatively if the dequeue and reattach logic 312 determines additional data (i.e., data identifying a flow which is included in the selected pipe) does not need to be serviced, the selected pipe will not be reattached to the primary calendar 308.

As mentioned above when describing step 416, upon receiving notification of a winning pipe, the dequeue and reattach logic 312 determines whether the pipe queue that corresponds to the winning pipe is empty. According to the methods and apparatus of copending application Ser. No. ______ filed on even date herewith (Attorney Docket No. ROC920030061), if the pipe queue that corresponds to the winning pipe is empty (i.e., the pipe queue has no pipe flow entries that need to be serviced during the time unit), the dequeue and reattach logic 312 may give the pipe queue corresponding to the selected pipe a credit (e.g., by setting a pipe credit bit for that pipe queue in the pipe queue table 314). However, no pipe or flow is serviced during the time unit. If a pipe queue has a credit, when a winning pipe flow entry is placed on that pipe queue in a subsequent time unit, the pipe queue table 314 notifies the dequeue and reattach logic 312 of this entry. The dequeue and reattach logic 312 will select the pipe flow entry from the pipe queue and will clear the pipe queue's win credit, as more fully described with reference to FIG. 5.

FIG. 5 illustrates a process according to the methods and apparatus of copending application Ser. No. ______ (Attorney Docket No. ROC920030061) of selecting from a main calendar a winning pipe that is empty (i.e., the pipe queue corresponding to the winning pipe includes no flows to be serviced during the time unit). Although autonomous flows may be included in the primary calendar 308, in this example it is assumed that only pipes are included in the primary calendar 308 as the disadvantage of no data transmission during a given time unit is experienced only by pipes, and is not experienced by autonomous flows.

FIG. 5 will be described with reference to FIG. 6 which is a block diagram of a plurality of memory addresses in a high priority calendar 608a, a medium priority calendar 608b and a low priority calendar 608c. In the example of FIG. 6, during a first time unit t₁, a memory address 610a, 610b, 610c respectively pointed to in each of the high, medium and low priority calendars 608a, 608b, 608c is empty. Therefore, absent use of the current invention (described below with references to FIGS. 3-4, and 7-9 no pipe will be serviced during the time unit t₁. During a time t₂, a memory address 612a, 612b and 612c are pointed to in the high, medium, and low priority calendars 608a-c, respectively. The memory address 612a in the high priority calendar 608a and the memory address 612c in the low priority calendar 608c include entries to be serviced during the time unit t₂. The entry from memory address 612a of the high priority calendar will be serviced during the time t₂ due to its higher priority.

During a time t₃, a memory address 614a, 614b, and 612c are pointed to in the high, medium and low priority calendars 608a-c, respectively. Because the memory address 612c of the low priority calendar 608c includes an entry that was to be serviced during the time t₂, during the time t₃, the pointer does not advance to another memory address of the low priority calendar 608c. As shown, during the time t₃, the memory address 614a, 614b, and 612c of the high, medium, and low priority calendars, respectively, include entries to be serviced during the time t₃.

Referring to FIG. 5, in step 502, the process flow of selecting a winning entry that is empty from the main calendar 308 begins. For reasons described above, and as shown in step 504 of FIG. 5, the entry from memory address 614a of the high priority calendar is selected as a winner to be serviced during time t₃. Because it is assumed in the example that all entries in the calendars are pipes, in step 506, it will be determined the selected entry (i.e., the winner) is a pipe. Consequently, step 508 is performed.

In step 508, it will be determined whether the selected pipe is empty. If it is determined that the winning pipe is not empty, step 510 is performed. In step 510, data from a flow included in the selected pipe is transmitted. Step 510 may include steps 416 and 418 of the method of scheduling a pipe flow shown in FIG. 4.

If it is determined in step 508, that the selected pipe is empty, step 512 is performed. As mentioned above, the selected pipe is empty if the pipe queue that corresponds to the selected pipe includes no entries. In step 512, as described above, a win credit is assigned to the pipe queue corresponding to the selected pipe (e.g., the pipe included in memory address 614a) during the time unit. Thereafter, in step 514, the process shown in FIG. 5 ends.

Therefore, although memory address 614b and memory address 612c of the medium and low priority calendars 608b and 608c include entries to be serviced during the time t₃, no pipe flow is serviced during the time unit because there is no entry being pointed to in the pipe queue for the selected pipe (e.g., the pipe included in memory address 614a). This results in an inefficient method of providing access to a limited system bandwidth.

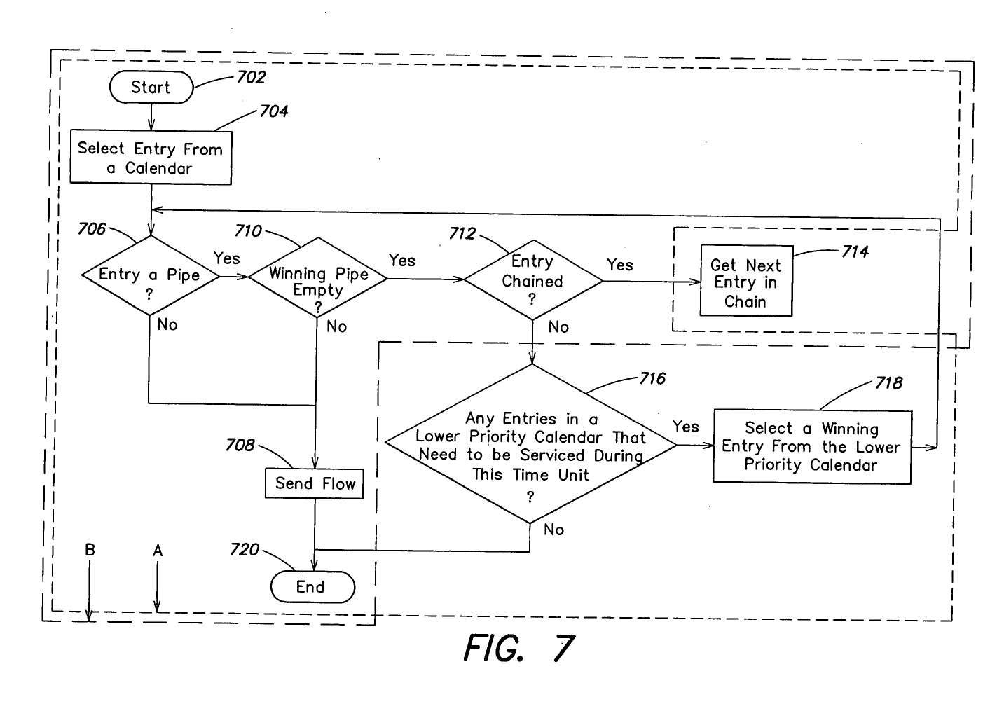

In contrast to the methods and apparatus of copending application Ser. No. ______ (Attorney Docket No. ROC920030061) filed on even date herewith, the present invention provides a network processor with hierarchical scheduling that includes methods and apparatus for selecting multiple entries to be serviced during a time unit. The operation of the scheduler logic 300 is now described with reference to FIG. 7 which illustrates such a method. For the example of FIG. 7 it will no longer be assumed that all entries in the main calendar are unchained. Similarly, it will be assumed in the example of FIG. 7 that a first entry selected from the primary calendar is a pipe. This assumption is made because an autonomous flow will never be empty and thus is not helpful in understanding the advantage provided by the current invention.

The method of FIG. 7 illustrates:
(1) a method of selecting another autonomous flow or pipe entry from the primary calendar 308 if the previously-selected pipe entry is an empty unchained entry during a time unit (shown in dotted box A); and
(2) a method of selecting another autonomous flow or pipe entry from the primary calendar 308 if the previously-selected pipe entry is an empty chained entry during a time unit (shown in dotted box B).

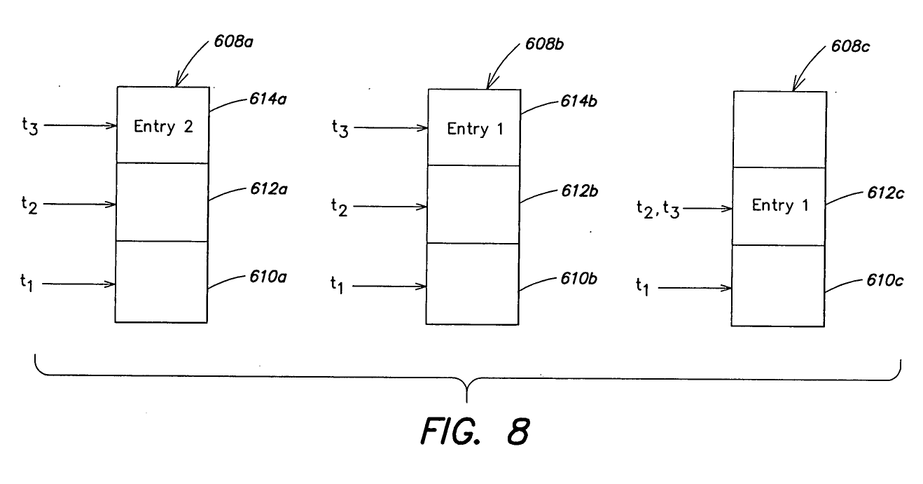

The method of selecting another autonomous flow or pipe entry from the primary calendar 308 if the previously-selected pipe entry is an empty unchained entry will be discussed with simultaneous reference to FIG. 7 and to FIG. 8, which illustrates a block diagram of a plurality of memory addresses in a high priority calendar 608a, a medium priority calendar 608b, and a low priority calendar 608c in which the inventive method is performed.

The process flow shown in FIG. 8 is similar to the process flow shown in FIG. 6 up to time unit t₃. During the time unit t₃, a memory address 614a, 614b, and 612c of the high, medium, and low priority calendars 608a-c, respectively, include entries to be serviced during the time unit t₃. With reference to FIG. 7, in step 702, the method of selecting another pipe entry from the primary calendar 308 if the previously-selected pipe entry is an empty unchained entry during a time unit (shown in dotted box A) begins. In step 704 of FIG. 7, due to its higher priority, the entry from memory address 614a of the high priority calendar 608a is selected as a winner to be serviced during the time t₃. In step 706, it is determined whether the selected entry (i.e., the winner) is a pipe. If the selected entry is not a pipe, it is an autonomous flow, and in step 708, data from the autonomous flow will be transmitted from the output port 132 of the network processor system 100 (FIG. 1). If the selected entry is determined to be a pipe, in step 710, it is determined whether the winning pipe is empty. As mentioned above, a pipe is empty if the pipe queue has no pipe flow entries that need to be serviced during the current time unit. If the winning pipe is not empty, step 708 is performed, and data from a pipe flow included in the winning pipe is transmitted from the output port 132 (FIG. 1).

If it is determined in step 710 that the selected pipe (e.g., the entry in the memory address 614a of the high priority calendar 608a) is empty, step 712 is performed. In step 712, it is determined whether the selected pipe entry is chained.

### Selected Pipe Entry is an Empty Unchained Entry

In step 712, it is assumed that the selected pipe entry is unchained. Consequently, step 716 is performed. In step 716, it is determined whether any lower priority calendars include a pipe or autonomous flow entry to be serviced during the time unit. For example, if it is determined (via the dequeue and reattach logic 312 and the pipe queue table 314) during the current time unit (e.g., t₃) that the pipe entry in the memory address 614a of the high priority calendar is empty, the scheduler logic 300 will determine whether the memory address 614b of the medium priority calendar 608b or the memory address 612c of the low priority calendar 608c includes a pipe or autonomous flow to be serviced during the time unit t₃. If no lower priority calendars include entries to be serviced during the time unit t₃, step 720 is performed, in which the method of FIG. 7 ends.

Alternatively, if a lower priority calendar includes a pipe or autonomous flow entry to be serviced during the time unit, step 718 is performed. For example, during the time t₃, the memory address 614b in the medium priority calendar and the memory address 612c in the low priority calendar include entries scheduled to be serviced during the time t₃, therefore step 718 is performed. In step 718, an entry from one of the lower priority calendars is selected as a winner during the time unit. Specifically, the pipe or autonomous flow entry in the memory address 614b of the medium priority calendar 608b will be selected to be serviced before the memory address 612c of the low priority calendar 608c will be selected. Once the entry from one of the lower priority calendars is selected as a winner during the time unit, the process returns to step 706 and it is determined whether or not the entry is a pipe.

In contrast to the method of FIG. 5 (wherein no data is transmitted during a time unit in which a winning pipe is empty), the inventive method of FIG. 7 (wherein another pipe entry from the primary calendar is selected during a time unit if the previously selected pipe entry is an empty unchained entry) efficiently provides access to a limited system bandwidth.

### Selected Pipe Entry is an Empty Chained Entry

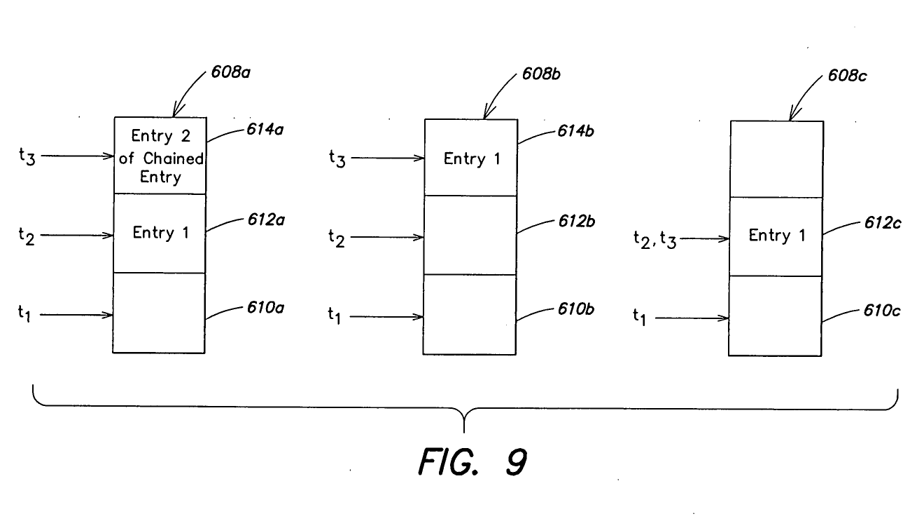

The method of selecting another autonomous flow or pipe entry from the primary calendar 308 if the previously-selected pipe entry is an empty chained entry during a time unit will be discussed with reference to FIG. 7 and with reference to FIG. 9, which illustrates a block diagram of a plurality of memory addresses in a high, medium, and low priority calendar 608a-c in which the inventive method is performed.

The process flow shown in FIG. 9 is similar to the process flows shown in FIGS. 6 and 8 up to time unit t₃. During the time unit t₃, a memory address 614a, memory address 614b, and the memory address 612c of the high, medium and low priority calendars 608a-c, respectively, include entries to be serviced during the time unit t₃. In step 702, the method of selecting another autonomous flow or pipe entry from the primary calendar 308 if the previously-selected pipe entry is an empty chained entry during a time unit (shown in dotted box B) begins. Steps 704, 708, 710 and 712 in the present method are the same as the steps in the method of selecting another autonomous flow or pipe entry from the primary calendar 308 if the previously-selected pipe entry is an empty unchained entry during a time unit (shown in dotted box A). However, in step 712, the selected entry will be determined to be a chained entry. Consequently, step 714 will be performed. In step 714, the next entry in the chain will be selected as the entry to be serviced. As described above, when the winner selected from the identified entry during the time unit is a chained entry, the winner will be replaced in the calendar by the next autonomous flow or pipe entry in the chain. For example, when a chained entry in memory address 614a of the high priority calendar 608a is selected as a winner (step 704), the next autonomous flow or pipe entry in the chain will replace the selected entry in the memory address 614a of the high priority calendar 608a (i.e., will be selected as a winner during the time t₃). Although the memory address 614b of the medium priority calendar 608b and the memory address 612c of the low priority calendar 608c also include entries to be serviced during the time t₃, the next entry of the chain in the memory address 614a of the high priority calendar 608a will be the next entry selected to be serviced during the time unit t₃. Once the next entry in the chain is selected as a winner during the time unit t₃, the process returns to step 706.

As described above, when a chained entry is selected as an entry to be serviced, the selected entry will be replaced in the calendar by the next autonomous flow or pipe entry in the chain. If the entry replacing the selected entry is the last entry of the chain, it will be an unchained entry in the primary calendar.

Like the method of selecting another pipe entry from the primary calendar if the previously selected pipe entry is an empty unchained entry, the present method (shown in dotted box B) efficiently provides access to a limited system bandwidth when an empty chained entry is selected. Accordingly, if the network processor system that includes the scheduler logic 300 of the present invention is coupled to one or more pipes that are oversubscribed and underutilized (i.e., a small percentage of all the pipe flows included in a pipe are active during a time unit), an empty pipe may frequently be selected to be serviced during a time unit. Consequently, rather than transmitting no data from the output port 132 of the network processor system, the present methods and apparatus will select another entry to be serviced during the time unit.

The foregoing description discloses only exemplary embodiments of the invention. Modifications of the above disclosed apparatus and method which fall within the scope of the invention will be readily apparent to those of ordinary skill in the art. For instance, while the present methods and apparatus disclose selecting to be serviced the last entry that was added to a chained entry first, alternatively, the first entry that was added to the chained entry may be selected to be serviced during a time unit. In response, the second entry to be added to the chained entry will replace the selected entry as the first entry of the chained entry.

Accordingly, while the present invention has been disclosed in connection with exemplary embodiments thereof, it should be understood that other embodiments may fall within the spirit and scope of the invention, as defined by the following claims.

1. A method comprising:
selecting a first winning entry from one of a plurality of main calendars during a time unit, the first winning entry indicating a first pipe to be serviced during the time unit;
determining that no pipe flow corresponding to the winning first pipe currently needs to be serviced during the time unit;
selecting a second winning entry from the plurality of main calendars during the time unit, the second winning entry indicating a second pipe or an autonomous flow to be serviced during the time unit; and
servicing the autonomous flow or a pipe flow corresponding to the second winning entry during the time unit.

2. The method of claim 1 wherein selecting the first entry from one of the plurality of main calendars during the time unit includes selecting the first winning entry from the highest priority calendar that indicates an entry that needs to be serviced.

3. The method of claim 1 wherein the first winning entry includes a first entry of a chain, the chain includes a plurality of pipe entries scheduled to be serviced during the time unit.

4. The method of claim 1 wherein selecting the first winning entry from one of the plurality of main calendars during the time unit includes selecting the first winning entry from one of the plurality of main calendars, each of which is of the different priority, during the time unit.

5. The method of claim 1 wherein selecting the first winning entry from one of the plurality of main calendars during the time unit includes selecting the first winning entry from one of the plurality of main calendars during a plurality of clock cycles.

6. The method of claim 1 wherein determining that no pipe flow corresponding to the winning first pipe currently needs to be serviced during the time unit includes accessing the pipe queue corresponding with the winning pipe for pipe flows that need to be serviced and determining that no pipe flow corresponding to the winning first pipe entry currently needs to be serviced during the time unit.

7. The method of claim 3 wherein selecting the second winning entry from one of the plurality of main calendars during the time unit includes selecting a second entry of the chain.

8. The method of claim 2 wherein selecting the second winning entry from one of the plurality of main calendars during the time unit includes selecting the second winning entry from a calendar of a lower priority than the highest priority calendar.

9. The method of claim 8 wherein selecting the second winning entry from one of the plurality of main calendars during the time unit includes selecting the second winning entry from a calendar of a lower priority than the highest priority calendar includes selecting the second winning entry from the highest priority calendar that has an entry indicating a pipe or autonomous flow to be serviced during the time unit.

10. The method of claim 1 wherein servicing the autonomous flow or pipe flow corresponding to the second winning entry during the time unit includes accessing the pipe queue corresponding to the second winning entry to select a pipe flow that needs to be serviced.

11. The method of claim 10 wherein servicing the autonomous flow or pipe flow corresponding to the second winning entry during the time unit includes servicing the highest priority pipe flow that is in the queue the longest time.

12. A network processor system comprising:
at least one memory adapted to store one or more quality of service priority parameters corresponding to one or more pipes and pipe flows; and
scheduler logic, coupled to the at least one memory, adapted to:
select a first winning entry from one of a plurality of main calendars during a time unit, the first winning entry indicating a first pipe to be serviced during the time unit;
determine that no pipe flow corresponding to the winning first pipe currently needs to be serviced during the time unit;
select a second winning entry from the plurality of main calendars during the time unit, the second winning entry indicating a second pipe or autonomous flow to be serviced during the time unit; and
service the autonomous flow or pipe flow corresponding to the second winning entry during the time unit.

13. The network processor system of claim 12 wherein the scheduler logic comprises:
a plurality of main calendars for storing at least one of an autonomous flow and a pipe that are scheduled to be serviced;
a plurality of secondary calendars for storing pipe flows that are scheduled to be serviced; and
a pipe queue table for storing a winning pipe flow in a queue for a pipe to which the pipe flow corresponds.

14. The network processor system of claim 12 wherein the scheduler logic further comprises:
enqueue and new attach logic for scheduling at least one of an autonomous flow and pipe flow to be serviced; and
dequeue and reattach logic for selecting at least one of an autonomous flow and a pipe flow to be serviced.

15. A method comprising:
selecting a first winning entry from one of a plurality of main calendars during a time unit, the first winning entry indicating a first pipe to be serviced during the time unit;
determining that no pipe flow corresponding to the winning first pipe currently needs to be serviced during the time unit;
selecting a second winning entry from the plurality of main calendars during the time unit, the second winning entry indicating a second pipe to be serviced during the time unit; and
servicing a pipe flow corresponding to the second winning entry during the time unit.

16. A method comprising:
selecting a first winning entry from one of a plurality of main calendars during a time unit, the first winning entry indicating a first pipe to be serviced during the time unit;
determining that no pipe flow corresponding to the winning first pipe currently needs to be serviced during the time unit;
selecting a second winning entry from the plurality of main calendars during the time unit, the second winning entry indicating an autonomous flow to be serviced during the time unit; and
servicing the autonomous flow corresponding to the second winning entry during the time unit.

17. A network processor system comprising:
at least one memory adapted to store one or more quality of service priority parameters corresponding to one or more pipes and pipe flows; and
scheduler logic, coupled to the at least one memory, adapted to:
select a first winning entry from one of a plurality of main calendars during a time unit, the first winning entry indicating a first pipe to be serviced during the time unit;
determine that no pipe flow corresponding to the winning first pipe currently needs to be serviced during the time unit;
select a second winning entry from the plurality of main calendars during the time unit, the second winning entry indicating a second pipe to be serviced during the time unit; and
service a pipe flow corresponding to the second winning entry during the time unit.

18. A network processor system comprising:
at least one memory adapted to store one or more quality of service priority parameters corresponding to one or more pipes and pipe flows; and
scheduler logic, coupled to the at least one memory, adapted to:
select a first winning entry from one of a plurality of main calendars during a time unit, the first winning entry indicating a first pipe to be serviced during the time unit;
determine that no pipe flow corresponding to the winning first pipe currently needs to be serviced during the time unit;
select a second winning entry from the plurality of main calendars during the time unit, the second winning entry indicating an autonomous flow to be serviced during the time unit; and
service the autonomous flow corresponding to the second winning entry during the time unit.
